(19) United States
(12) Patent Application Publication
(10) Pub. No.: US 2008/0065925 A1
(43) Pub. Date: Mar. 13, 2008

(54) SYSTEM AND METHODS FOR SYNCHRONIZING PERFORMANCES OF GEOGRAPHICALLY-DISPARATE PERFORMERS

(76) Inventors: James C. Oliverio, Gainesville, FL (US); Andrew M. Quay, Gainesville, FL (US); Joella A. Wilson, Gainesville, FL (US)

Correspondence Address: AKERMAN SENTERFITT, P.O. BOX 3188, WEST PALM BEACH, FL, 33402-3188, US

(21) Appl. No.: 11/852,064

(22) Filed: Sep. 7, 2007

Related U.S. Application Data
(60) Provisional application No. 60/824,929, filed on Sep. 8, 2006.

(51) Int. Cl. G06F 1/12

(52) U.S. Cl. 713/401

(57) ABSTRACT

A method for synchronizing performances of geographically disparate performers is provided. The method includes setting one or more beat clocks, each beat clock corresponding to a remotes site configured to convey streaming audio over a data communications network to a remotely-located master site. Each beat clock, according to the method, is time-shifted based upon delay and throughput latencies relative to a current-beat time set at the master site. The method further includes receiving at the master site audio renderings of performances by the one or more performers located each remote site.

Additionally, when combined with various types of digital media devices, the techniques, mechanisms, and procedure of the invention can create a virtual online media environment. The online media environment can support the composition, performance, recording and playback of multiple live video images, the composite positioning of said multiple live video images, the dynamic visual and aural display of the status of underlying data systems employed in the creating and operating said virtual online media environment, and the real-time user-customizable composite view of each.

### CROSS-REFERENCE TO RELATED APPLICATIONS

The present application claims the priority of U.S. Provisional Application Ser. No. 60/824,929 filed on Sep. 8, 2006.

### STATEMENT REGARDING FEDERALLY SPONSORED RESEARCH OR DEVELOPMENT

Not applicable.

### FIELD OF THE INVENTION

The present invention is related to the field of data communication networks, and, more particularly, the utilization of such networks for jointly rendering performances of different performers at different sites remotely located from one another.

### BACKGROUND OF THE INVENTION

It has been for sometime a goal of performers to be able to render their separate contributions to a joint performance in a coordinated manner by utilizing data communications networking technologies. Achieving the goal, however, remains problematic, especially with respect to musical, theatrical and other real-time collaborative performances.

Synchronizing performances by geographically-disparate performers, particularly musicians, is complicated by the inherent latencies in data-communications-network-based performances. Research indicates that one-way delays in conveying audio renderings of performances in data packets over a data communications network are typically 100 milliseconds (ms). Network-based and individual system latencies further complicate any effort to synchronize “live” performances in real time. Such latencies can include delays due to analog-to-digital conversions and subsequent reverse conversions from digital to analog, data buffering and de-jitter buffering, data compression and decompression, as well as data queuing, all of which typically occur at different nodes or sites of the data communications network.

A conventional approach is for performers at a remote site to begin a performance and transmit the resulting audio to another site where other performers layer audio renderings of their performances over those received from the prior site. Successive performances can be layered at each site traversed until a final mix is delivered to an audience at the last site in the chain.

Even though the final mix heard by the audience may be a well-synchronized performance, the performers at one site are not able to hear performances rendered by other performers at geographically-disparate sites. This is a particular drawback to musicians since the spontaneity of their performances and the intuitive “feel” of the performers' interaction can be lessened if the musicians are forced to perform more or less isolated from one another.

Accordingly, there is a need for more effective and efficient techniques for synchronizing the performances of geographically-disparate performers, especially musical performers. In particular, there is a need for a technique that permits performers to hear the audio renderings of co-performers as they each jointly contribute to a “live” performance.

### SUMMARY OF THE INVENTION

The invention provides a system and methods for synchronizing the performances of geographically-disparate performers. More particularly, the invention can synchronize the performances of geographically-disparate performers in real-time. An underlying aspect of the invention is the utilization of a beat clock that enables performers at a network-connected site to hear other performers performing at other remote sites as though all the performers were co-located. According to one embodiment the invention, the beat clock operates in a manner similar to a so-called “click track,” but with the invention the effect is much more dynamic in terms of user controllability.

One embodiment of the invention is a network-based system, termed a Netronome, for synchronizing performances of geographically disparate performers. The system can include a master site having an audio interface, a data communications network interface for conveying and receiving streaming audio over the data communications network, and a master clock. The system further can include one or more remote sites, each having an audio interface, a data communications network interface for conveying streaming audio to and receiving streaming audio from the master site via the data communications network, and a beat clock. The system can be configured to set the beat clock by time-shifting a current-beat time set at the master site by the master clock, the time-shifting being based upon delay and throughput latencies.

Another embodiment of the invention is a method for synchronizing performances of geographically disparate performers. The method can include the step of setting a beat clock for at least one remote site at which one or more performers is located, wherein the at least one remote site is configured to convey streaming audio over a data communications network to a remotely-located master site. The step of setting a beat clock for a particular remote site, more particularly, can include time-shifting the beat clock based upon delay and throughput latencies relative to a current-beat time set at the master site. The method also can include receiving at the master site audio renderings of performances by the one or more performers located at the at least one remote site.

Still another embodiment of the invention is a computer-readable storage medium for use with a data communication network comprising a master site and at least one remote site. The storage medium can comprise computer instructions for causing a computer to set a beat clock for the at least one remote site at which one or more performers is located, wherein the beat clock is time-shifted based upon delay and throughput latencies relative to a current-beat time set at the master site, and to direct the master site to receive audio renderings of performances by the one or more performers located at the at least one remote site.

Yet another embodiment of the invention is a system comprising digital media devices and techniques, as described herein, which create a virtual online media environment, termed a NOME (NetroNome Online Media Environment). The NOME can support the composition, performance, recording and playback of multiple live video images, the composite positioning of multiple live video images, the dynamic visual and aural display of the status of underlying data systems employed in the creating and operating of virtual online media environment, and real-time user-customizable composite views of each. The suite of media tools and techniques can expand the creative and technical output from the live synchronized performances of any number of live geographically disparate performers.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic diagram of a system for synchronizing performances of geographically-disparate performers, according to one embodiment of the invention.

FIG. 2 is a schematic diagram of a remote site of the system illustrated in FIG. 1.

FIG. 3 is a schematic diagram of a master site of the system illustrated in FIG. 1.

FIG. 4 is schematic diagram of a system for creating a virtual online media environment, according to another embodiment of the invention.

FIG. 5 is a schematic diagram of an exemplary synchronization of various modalities of performances performed by geographically-disparate performers at a master site and a plurality of remote sites, according to another embodiment of the invention.

FIG. 6 is a time chart of an exemplary synchronization of performances performed by geographically-disparate performers at a master site and a remote site, according to one embodiment of the invention.

FIG. 7 is a time chart of an exemplary synchronization of performances performed by geographically-disparate performers at a master site and a plurality of remote sites, according to one embodiment of the invention.

### DETAILED DESCRIPTION

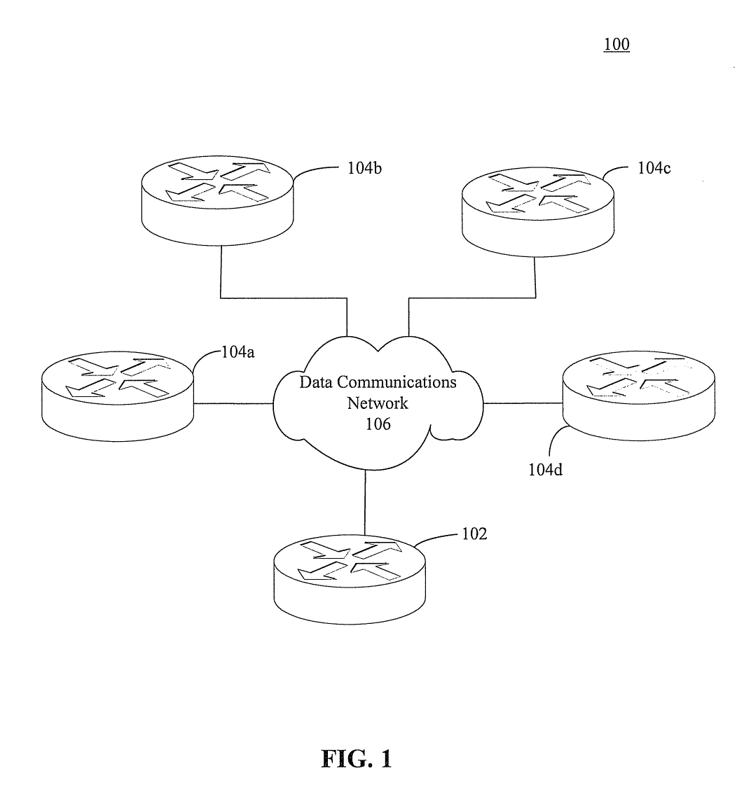

FIG. 1 is a schematic view of a system 100 for synchronizing performances of geographically disparate performers, according to one embodiment of the invention. The system 100 illustratively comprises a master site 102, as well as one or more remote sites 104a-d. The master site 102 and the representative remote sites 104a-d are each located remotely from one another. The master site 102, however, communicates with each of the remote sites 104a-d via a data communications network 106. The data communications network 106 can be for example a local area network (LAN) or related type of network. Moreover, the data communications network 106 can comprise different interconnected networks, such as the Internet.

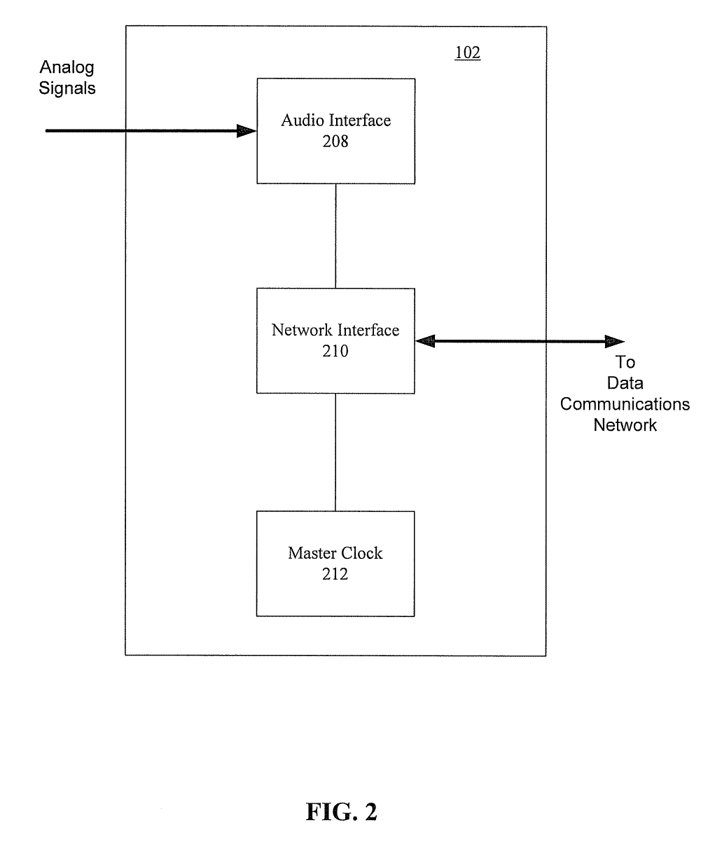

Referring additionally to FIG. 2, the master site 102 is schematically illustrated. The master site 102 illustratively includes an audio interface 208, a data communications network interface 210, and a master clock 212, each in electronic communication with the others. The audio interface 208 can include an analog-to-digital capability for digitizing received audio signals. In particular, the audio interface 208 can be used, for example, to capture a musical performance by a musician located at the master site 102. The digitized data can be provided to the data communications network interface 210 to be conveyed to the data communications network 106 in the form of an audio stream of packetized data. The audio interface 208 can also be configured to receive streaming audio conveyed over the data communications network 106.

Optionally, a video interface (not explicitly shown) can supplement, or be substituted for, the audio interface 208. Therefore, according to other embodiments of the invention, streaming data, comprising audio, video, or both audio and video, as well as other types of data, can be conveyed and received via the data communications network 106 by utilizing one or more different types of interfaces.

The master clock 212 is used to set a current beat time, T. The current beat time, as described more particularly below, provides a time that is used by at each of the illustrated remote sites 104a-d to synchronize the performances of musicians located at the particular remote site with those of other geographically-disparate performers, whether performing at another remote site or at the master site 102.

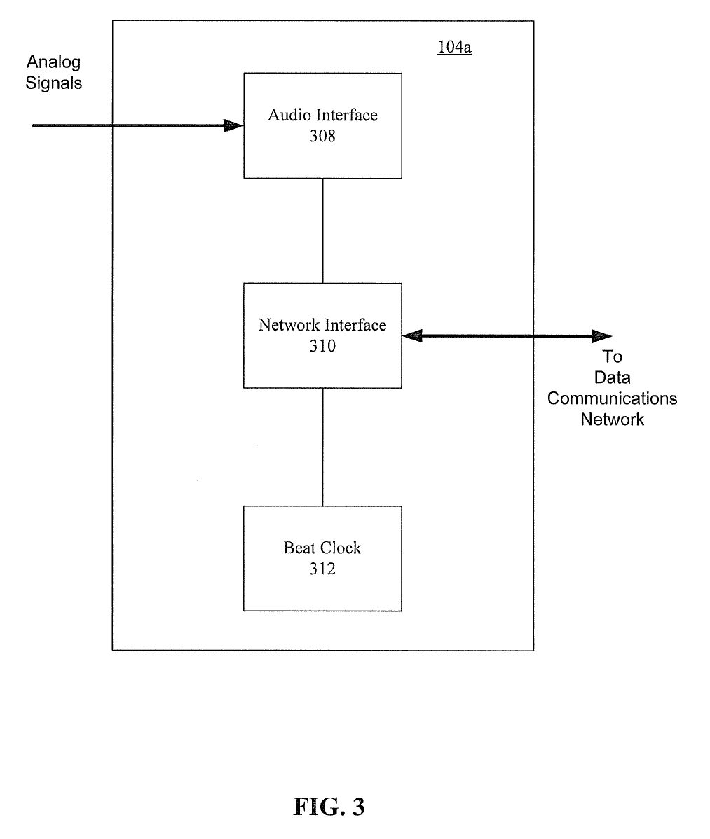

Referring additionally to FIG. 3, an exemplary remote site 104a is schematically illustrated. The remote site 104a illustratively includes an audio interface 308, a data communications network interface 310 for conveying streaming audio to and receiving streaming audio from the master site via the data communications network, and a beat clock 312. The audio interface 308, the data communications network interface 310, and the beat clock 312 are each in electronic communication with one another. The remote site 104a is configured with dedicated hardwired circuitry (not explicitly shown) and/or software code configured to run on one or more logic-based processors (not explicitly shown) to set the beat clock. Operatively, the beat clock 312 is set by time shifting a current-beat time set at the master site by the master clock, the time shifting being based upon delay and throughput latencies.

Each individual remote site 104a-d sets its own beat clock 312 (or dynamic click track). To set its own beat clock 312, the particular remote site 104a sends via the data communications network 106 a request to the master site 102. The request can be a time-stamped request instruction that indicates a time, t₁, that the request is sent. The master site 102, in response to the request, sends to the requesting remote site 104a via the data communications network 106 the current beat time, T, set and maintained by the master clock 212. The remote site 104a computes a first time-shifted current beat time based upon the current beat time, T, and a time t₂ at which the response to its request was received from the master site 102. The first time-shifted current beat time is computed to be the current beat time, T, set by the master clock 212, plus one-half times the difference between the time when the request was sent, t₁, and the response received, t₂: t₃=T+½(t₂−t₁).

The remote site 104a can then transmit to other sites a ticking sound, or “beat,” of the computed, first time-shifted beat time, t₃. The beat can be transmitted in the form of streaming audio over the data communications network 106. The master site 102 receives the audio-based beat and remotely advances the beat clock 312 of the remote site 104a by a factor t_{delta} to synchronize audio with the current beat time, T, of the master clock 212. The remote advancement of the beat clock 312 of the remote site 104a generates a new, or second time-shifted, beat time, t₄: t₄=t₃+t_{delta}. This additional time shifting can be performed by system-related latencies in the streaming audio. In practice, musicians or other performers performing at the remote site 104a can perform according to the beat time t₄, while those performing at the master site 102 can perform according to the current beat time, T, set and maintained by the master clock 212.

To initiate a musical performance, according another embodiment of the invention, the master site 102 can instruct each remote site 104a-d to re-synchronize their respective clocks. This further time-shifting step can be performed to accommodate network-based latencies. Operatively, the master site 102 instructs each of the remote sites 104a-d to repeat the steps of sending a time-stamped request to the master site and computing a new beat time by talking the sum of the current beat time, T, plus one-half the difference between the time a response to the request was received and the time that the request was sent, as already described.

The resulting time re-calibration takes into account network-based latencies. The earlier-determined time factor, t_{delta}, can then be added to generate a re-synchronized beat time for the remote clock 312 at each particular remote site 104a. Again, each performer at each remote site can perform based on the time set by the particular remote clock at which the performer is located, while those performing at the master site can perform according to the time set by the master clock 212.

With the system 100, each of the performers at a remote site can be provided a rendering of periodic beats based upon the re-synchronized beat clock such that geographically-disparate performers can synchronize their respective performances that contribute to a single, synchronized performance. The periodic beats provided can be rendered audibly, so as to be heard by the performers. Alternatively, or additionally, the periodic beats can be rendered visually. Still further, the periodic beats alternatively or additionally can comprise various types of visually-displayed timing indicators. Periodic beats comprising at least one of an audio rendering of periodic beats, a visual rendering of periodic beats, and visually-displayed timing indicators also can be provided to each performer located at the master site.

Accordingly, for a plurality of remote sites 104a-d, different beat clocks, each uniquely corresponding to a particular one of the plurality of remote sites, can be set so that geographically-disparate performers can synchronize their respective performances. Each beat clock corresponding to a particular remote site, more particularly, can be set by time-shifting each beat clock based upon network latency. The system 100 thus provides to each performer at each remote site 104a-d, a rendering of periodic beats based upon the beat clock, while also providing a rendering of periodic beats based upon the current-beat time set at the master site 102 to each performer located at the master site, wherein the rendering of periodic beats comprises at least one of an audio rendering of periodic beats, a visual rendering of periodic beats, and visually-displayed timing indicators.

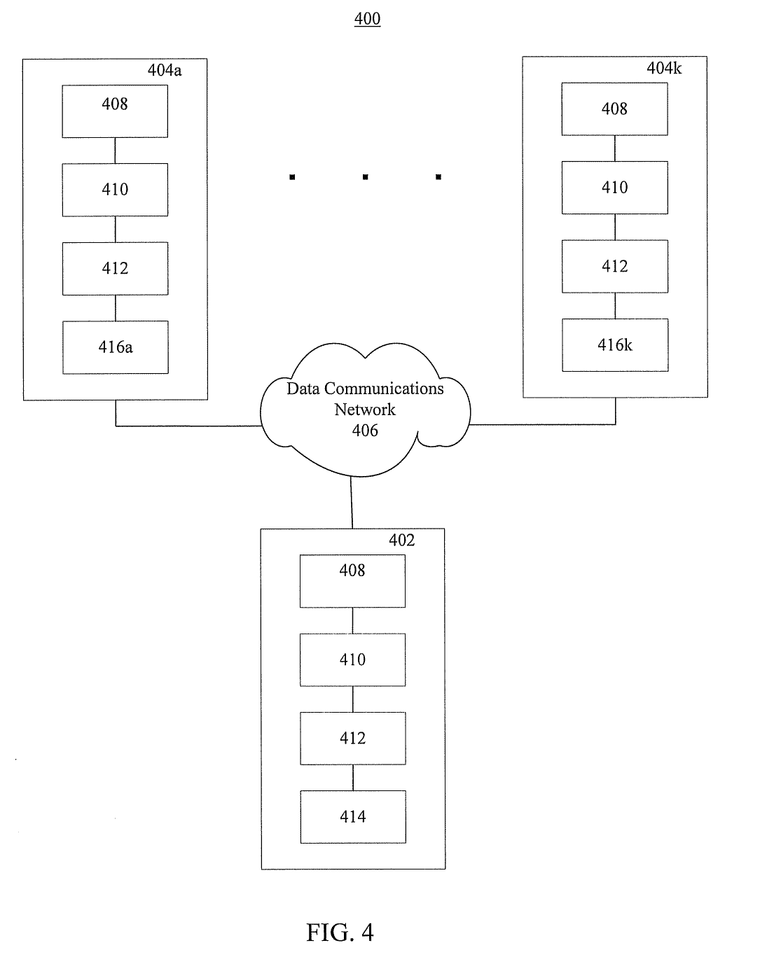

FIG. 4 is a schematic view of system 400, according to another embodiment of the invention. The system 400 creates a virtual online media environment by combining a variety of types of digital media with the techniques described herein. The virtual online media environment supports the composition, performance, recording and playback of multiple live video images, the composite positioning of said multiple live video images, the dynamic visual and aural display of the status of underlying data systems employed in the creating and operating of the virtual online media environment, and the real-time user-customizable composite view of each.

Illustratively, the system 400 includes a master site 402 and a plurality of remote sites 404a-404k, each communicatively linked via a data communications network 406. The master site 402 and each remote site 404a-404k includes one or more multimedia processors 408 for processing video, audio, and/or other multimedia data. The master site 402 and each remote site 404a-404k further includes a data communications interface 410 for receiving, rendering, and/or conveying multimedia data over the data communications network 406. At least some of the sites 402, 404a-404k include a video and/or an audio interface (shown as a composite interface 412) for capturing and conveying visual and audio performances by actors, musicians, conference participants, or other types of performers. Based upon the techniques already described, the performances occurring at the different sites 402, 404a-404k can be synchronized so that the respective performances can be rendered coherently at one of the sites, preferably the master site 402, thereby providing a real-time single, coherent performance presentation that incorporates the performance contributions of geographically-disparate performers at the various sites.

The synchronization can be achieved using at least one master clock 414 positioned at the master site 402, and at least one beat clock at each remote site 404a-404k. Each remote site 404a-404k is configured to receive from the master site 402 one or more timing signals. Based upon the one or more timing signals—such as a signal for generating a series of audible beats and/or visually-displayed time indicators—each remote site 404a-404k sets its own one or more beat clocks 416a-416k. Each beat clock 416a-416k, more particularly, is set by time-shifting a current-beat time set at the master site 402 by the master clock 414, the time-shifting being based upon delay and throughput latencies pertaining the particular remote site. Accordingly, the composition, performance, recording and playback of multiple live video images, the composite positioning of multiple live video images, the dynamic visual and aural display of the status of underlying data streams employed in the creation and operation of the virtual online media environment, and the real-time user-customizable composite view of each can be efficiently and effectively supported by the system 400. The described suite of media tools and techniques can thus expand the creative and technical output from the live synchronized performances of any number of live geographically disparate performers.

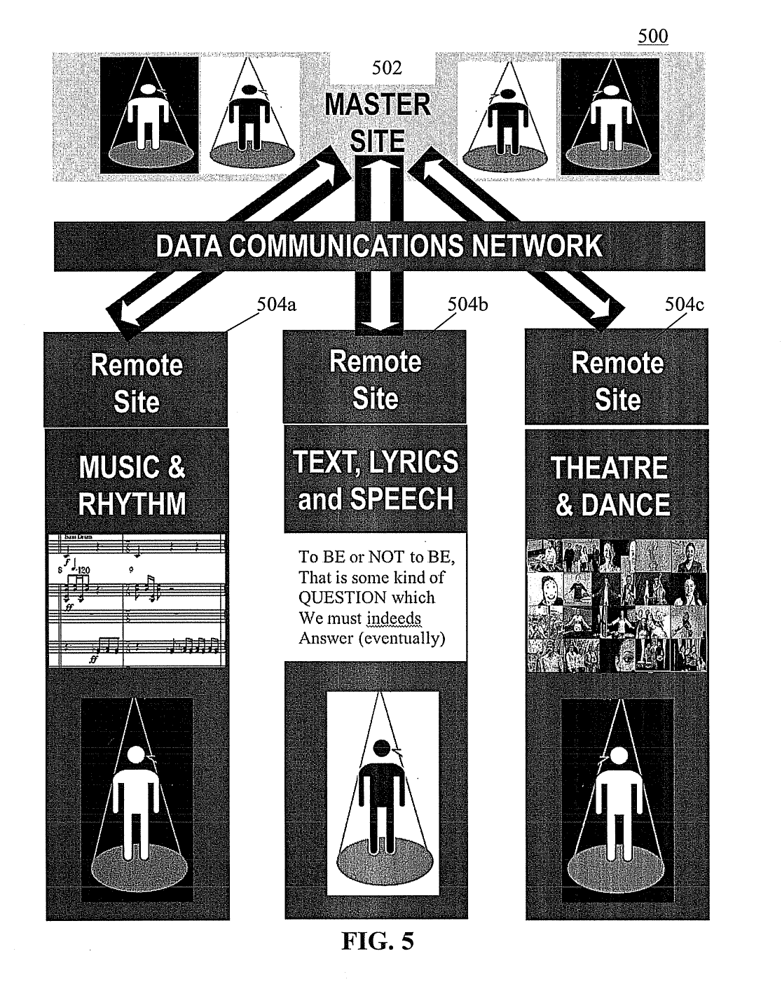

FIG. 5 schematically illustrates the manner in which, with a system 500 according to the invention described, various modalities of an exemplary performance performed by geographically-disparate performers at a master site 502 and a plurality of remote sites 502a-c can be synchronized by different mechanisms, according to yet another embodiment of the invention. These above-described mechanisms include, for example, a beat clock, audio cues, visual cues, and/or visually-displayed synchronized time indicators.

### EXAMPLES

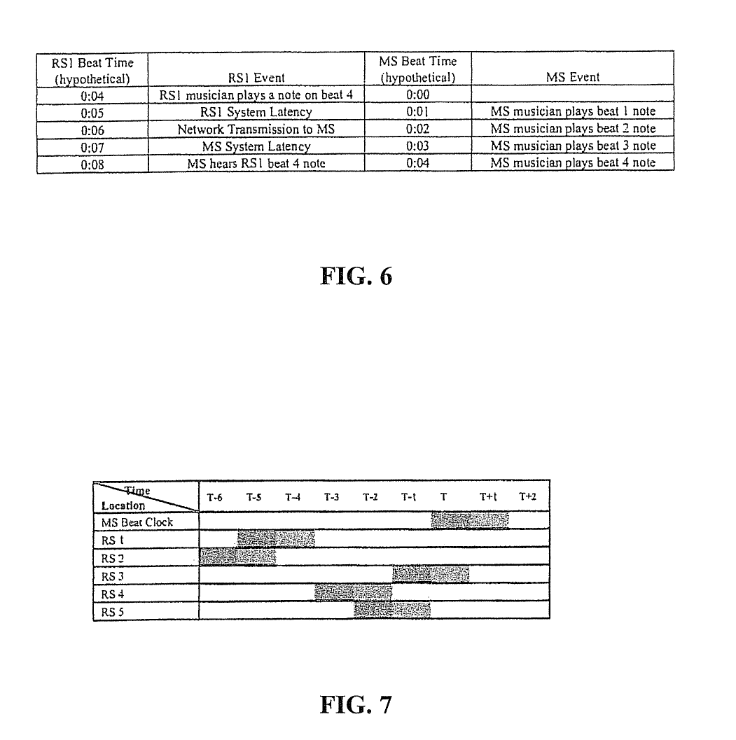

FIG. 6 provides a time chart for an exemplary performance in which the respective performance contributions of geographically-disparate performers are synchronized according to an embodiment of the invention. The time chart compares the respective “beat times” generated at the master site by a master clock and those generated at a remote site. At remote site RS1 a musical note is played ahead of the time set by the master clock, the master site being the primary venue to compensate for network and system propagation delays as described above.

FIG. 7 provides a time chart corresponding to an exemplary performance of musicians remotely located from one another and synchronized according an embodiment of the invention. musical notes played at a master site and different ones of a plurality of remote sites. The chart shows a sequence of discrete times, T−6, . . . , T, . . . , T+2, and the corresponding occurrence of notes at the respective sites.

The invention can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof.

We claim:

1. A method for synchronizing performances of geographically disparate performers, the method comprising:
setting a beat clock for at least one remote site at which one or more performers is located, wherein the at least one remote site is configured to convey streaming data over a data communications network to a remotely-located master site, and wherein the beat clock is time-shifted based upon delay and throughput latencies relative to a current-beat time set at the master site;
receiving at the master site renderings of performances by the one or more performers located at the at least one remote site.

2. The method of claim 1, wherein the step of setting the beat clock comprises:
sending from the remote site to the master site a master-clock request indicating a first current time when the request was sent from the at least one remote site to the master site;
receiving from the master site the current-beat time; and
computing a first time-shifted current-beat time by adding to the current-beat time one-half the difference between the first current time and a second current time, the second current time corresponding to a time when a response to the request was received at the at least one remote site from the master site.

3. The method of claim 2, wherein the step of setting the beat clock further comprises computing a second time-shifted current-beat time by time-shifting the first time-shifted current beat time based upon a determined throughput latency of the streaming audio.

4. The method of claim 3, further comprising time-shifting the second time-shifted current-beat time based upon a determined network latency to thereby re-synchronize the beat clock with the current-beat time set at the master site.

5. The method of claim 4, further comprising providing to each of the performers at the at least one remote site a rendering of periodic beats based upon the re-synchronized beat clock, wherein the rendering of periodic beats comprises at least one of an audio rendering of periodic beats, a visual rendering of periodic beats, and visually-displayed timing indicators.

6. The method of claim 4, further comprising providing to each performer located at the master site a rendering of periodic beats, wherein the rendering of periodic beats comprises at least one of an audio rendering of periodic beats, a visual rendering of periodic beats, and visually-displayed timing indicators.

7. The method of claim 3, wherein the at least one remote site comprises a plurality of remote sites and wherein the step of setting the beat clock comprises setting a different beat clock, each different beat clock uniquely corresponding to one of the plurality of remote sites.

8. The method of claim 7, wherein the step of setting each beat clock corresponding to one of the plurality of remote sites further comprises time-shifting each beat clock based upon network latency.

9. The method of claim 1, further comprising providing a rendering of periodic beats based upon the beat clock to each performer at the at least one remote site while also providing a rendering of periodic beats based upon the current-beat time set at the master site to each performer located at the master site, wherein the rendering of periodic beats comprises at least one of an audio rendering of periodic beats, a visual rendering of periodic beats, and visually-displayed timing indicators.

10. A system for synchronizing performances of geographically disparate performers, the system comprising:
a master site having an audio interface, a data communications network interface for conveying and receiving streaming data over the data communications network, and a master clock; and
at least one remote site having an audio interface, a data communications network interface for conveying streaming data to and receiving streaming data from the master site via the data communications network, and a beat clock;
wherein the at least one remote site is configured to set the beat clock by time-shifting a current-beat time set at the master site by the master clock, the time-shifting being based upon delay and throughput latencies.

11. A system for creating a virtual online media environment, the system comprising a master site having at least one multimedia processor, a data communications network interface for conveying and receiving multimedia data processed by the at least one multimedia processor over the data communications network, and at least one master clock; and
a plurality of remote sites, each site having at least one multimedia processor, a data communications network interface for conveying and receiving over the data communications network multimedia data processed by the at least one multimedia processor, and at least one beat clock;
wherein each remote site is configured to receive from the master site one or more timing signals and to set, based upon at least one timing signal, at least one beat clock by time-shifting a current-beat time set at the master site by the master clock, the time-shifting being based upon delay and throughput latencies.

12. A computer-readable storage medium for use with a data communication network comprising a master site and at least one remote site, the storage medium comprising computer instructions for:
setting a beat clock for the at least one remote site at which one or more performers is located, wherein the beat clock is time-shifted based upon delay and throughput latencies relative to a current-beat time set at the master site;
causing the master site to receive renderings of performances by the one or more performers located at the at least one remote site.

13. The computer-readable storage medium of claim 12, wherein setting the beat clock comprises:
sending from the remote site to the master site a master-clock request indicating a first current time when the request was sent from the at least one remote site to the master site;
receiving from the master site the current-beat time; and
computing a first time-shifted current-beat time by adding to the current-beat time one-half the difference between the first current time and a second current time, the second current time corresponding to a time when a response to the request was received at the at least one remote site from the master site.

14. The computer-readable storage medium of claim 13, wherein setting the beat clock further comprises computing a second time-shifted current-beat time by time-shifting the first time-shifted current beat time based upon a determined throughput latency of the streaming audio.

15. The computer-readable storage medium of claim 14, further comprising computer instructions for time-shifting the second time-shifted current-beat time based upon a determined network latency to thereby re-synchronize the beat clock with the current-beat time set at the master site.

16. The computer-readable storage medium of claim 15, further comprising computer instructions for providing to each of the performers at the at least one remote site, based upon the re-synchronized beat clock, at least one of an audio rendering periodic beats, a visual rendering of periodic beats, and visually-displayed timing indicators.

17. The computer-readable storage medium of claim 15, further comprising computer instructions for providing to each performer located at the master site, based upon the current-beat time set at the master site, at least one of an audio rendering periodic beats, a visual rendering of periodic beats, and visually-displayed timing indicators.

18. The computer-readable storage medium of claim 12, wherein the at least one remote site comprises a plurality of remote sites, and wherein setting the beat clock comprises setting a different beat clock, each different beat clock uniquely corresponding to one of the plurality of remote sites.

19. The computer-readable storage medium of claim 18, wherein setting each beat clock corresponding to one of the plurality of remote sites further comprises time-shifting each beat clock based upon network latency.

20. The computer-readable storage medium of claim 12, further comprising computer instructions for providing to each performer at the at least one remote site, based upon the current-beat time set at the master site, a rendering of periodic beats while also providing a rendering of periodic beats to each performer located at the master site, the periodic beats comprising at least one of an audio rendering of periodic beats, a visual rendering of periodic beats, and visually-displayed timing indicators.
